(19) United States
(12) Patent Application Publication
(10) Pub. No.: US 2023/0182510 A1
(43) Pub. Date: Jun. 15, 2023

(54) SYSTEMS AND METHODS FOR TIRE TREAD WEAR SENSING AND ELECTROSTATIC DISCHARGE

(71) Applicant: The Goodyear Tire & Rubber Company, Akron, OH (US)

(72) Inventors: Junling Zhao, Hudson, OH (US); Marc Borowczak, Hartville, OH (US); Peter Jung-min Suh, Stow, OH (US); Jeffrey McKay West, Uniontown, OH (US); James Gregory Gillick, Akron, OH (US); Michael William Kestner, Canton, OH (US)

(21) Appl. No.: 18/059,563

(22) Filed: Nov. 29, 2022

Related U.S. Application Data
(60) Provisional application No. 63/289,670, filed on Dec. 15, 2021.

(51) Int. Cl. B60C 19/08; B60C 11/24

(52) U.S. Cl. CPC B60C 19/08; B60C 11/243; B60C 2019/004

(57) ABSTRACT

Disclosed are various embodiments for sensing wear of a tire tread and for providing for electrostatic discharge of electrostatic charge buildup in a vehicle. Various sensor structures and electrostatic discharge structures are created using conductive rubber compositions and/or other elements to achieve tire tread wear sensing and discharge of electrostatic buildup. Such structures include conductors made of conductive rubber compositions, for example, having an uncured or cured electrical resistance at 23° C. less than about 10 KΩ when formed into a wire about 254 millimeters long and 2 millimeters in diameter.

### BACKGROUND

In the manufacture of a pneumatic tire, the tire is typically built on the drum of a tire-building machine, which is known in the art as a tire building drum. Numerous tire components are wrapped about and/or applied to the drum in sequence, forming a cylindrical-shaped tire carcass. The tire carcass is then expanded into a toroidal shape for receipt of the remaining components of the tire, such as a belt package and a rubber tread. The completed toroidally-shaped unvulcanized tire carcass, which is known in the art at that stage as a green tire, is then inserted into a mold or press for forming of the tread pattern and curing or vulcanization.

The use of tread wear indicators that are formed on a tire tread before or after curing is known in the art. For example, prior art mechanical tread wear indicators include color indicia disposed below certain tread elements, tie bars disposed in the tread grooves, or characters formed in the tread elements, all of which provide a visual indicator of wear. Such mechanical indicators may be difficult for a vehicle operator to see, and thus do not easily provide information to the operator.

In addition, it is often desirable to collect electronic data for the wear state of the tire. The data can be communicated to electronic systems of the vehicle, such as vehicle stability and/or braking systems, in order to provide improved control of the vehicle and to monitor or track driving behavior. Mechanical tread wear indicators are not able to provide such data to electronic systems of the vehicle.

To provide an indication of tire wear to vehicle electronic systems, prior art indirect wear estimation techniques were developed. Such techniques involve estimation of tire wear through certain tire and vehicle parameters, rather than direct measurement of wear. For example, tire pressure, tire temperature, vehicle speed, vehicle mileage, vehicle acceleration and other parameters may be employed to estimate tire wear. Such indirect estimation of tire wear can be difficult to perform accurately, and typically involves complex modeling techniques.

In order to provide a wear indication to vehicle electronic systems based on a direct measurement of tire wear, prior art electronic wear sensors were developed. Such sensors are known in the art as direct wear sensors, as they attempt to directly measure tire wear, rather than providing an estimate from indirect means. By way of example, prior art direct wear sensors include resistance-based electronic sensors that typically are incorporated into tread elements of tires. As the tread element wears, resistors in the sensor also wear, leading to a change in the electrical resistance of the sensor. By measuring the resistance of the sensor and transmitting the measured resistance data to a processor, wear of the tread can be determined.

While prior art direct wear sensors are acceptable for their intended purpose, many such sensors are difficult to install in the tire. Other direct wear sensors cannot withstand the harsh operating environment of the tire for a prolonged period, such as the recommended life of the tire. Still other direct wear sensors are not capable of maintaining precise and repeatable indication of tire wear over the recommended life of the tire.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a vehicle with one or more tires that include a tread wear sensor plug according to various embodiments of the present disclosure.

FIG. 2 is a perspective cross-sectional view of a tire shown in FIG. 1, prior to installation of the tread wear sensor plug according to various embodiments of the present disclosure.

FIG. 3 is an enlarged schematic perspective view of a tire shown in FIG. 2 according to various embodiments of the present disclosure.

FIG. 4 is a perspective view of a TPMS sensor employed in the exemplary embodiment of the tire with a tread wear sensor plug if FIG. 2 according to various embodiments of the present disclosure.

FIG. 5 is a cross-sectional view of the tread wear plug employed in the exemplary embodiment of the tire with a tread wear sensor plug of FIG. 2 according to various embodiments of the present disclosure.

FIG. 6 is a cross-sectional perspective view of the tread wear plug shown in FIG. 5 installed in the tire shown in FIG. 2 according to various embodiments of the present disclosure.

FIG. 7 is a cross-sectional perspective view of the tread wear plug shown in FIG. 5 installed in the tire shown in FIG. 2, with the tire in an unworn state according to various embodiments of the present disclosure.

FIG. 8 is a cross-sectional perspective view of the tread wear plug shown in FIG. 5 installed in the tire shown in FIG. 2, with the tire in a worn state according to various embodiments of the present disclosure.

FIG. 9 is a partial cross-sectional perspective view of a portion of a tire of FIG. 1 including a chimney according to various embodiments of the present disclosure.

FIG. 10 is an example of a side cross-sectional view of the tire of FIG. 9 according to various embodiments of the present disclosure.

FIG. 11 is a partial cross-sectional perspective view of a portion of a tire of FIG. 1 including a conductive insert according to various embodiments of the present disclosure.

FIG. 12 is an example of a side cross-sectional view of the tire of FIG. 11 according to various embodiments of the present disclosure.

FIG. 13 is a partial cross-sectional perspective view of a portion of a tire of FIG. 1 including a tread wear sensor plug according to various embodiments of the present disclosure.

FIG. 14 is another partial cross-sectional perspective view of a portion of a tire of FIG. 1 including a tread wear sensor plug according to various embodiments of the present disclosure.

FIGS. 15A-C depict various views of a further example of a tread wear sensor plug that includes electrostatic discharge section to be installed in the tire of FIG. 1 according to various embodiments of the present disclosure.

### DEFINITIONS

“Axial” and “axially” mean lines or directions that are parallel to the axis of rotation of the tire.

“Axially inward” and “axially inwardly” refer to an axial direction that is toward the axial center of the tire.

“Axially outward” and “axially outwardly” refer to an axial direction that is away from the axial center of the tire.

“Bead” means that part of the tire comprising an annular tensile member wrapped by ply cords and shaped, with or without other reinforcement elements such as flippers, chippers, apexes, toe guards and chafers, to fit the design rim.

“CAN bus” is an abbreviation for controller area network.

“Carcass” means the tire structure apart from the belt structure, tread, undertread, and sidewall rubber over the plies, but including the beads.

“Circumferential” means lines or directions extending along the perimeter of the surface of the annular tread perpendicular to the axial direction.

“Equatorial plane (EP)” means the plane perpendicular to the tire's axis of rotation and passing through the center of its tread.

“Footprint” means the contact patch or area of contact created by the tire tread with a flat surface, such as the ground, as the tire rotates or rolls.

“Inboard side” means the side of the tire nearest the vehicle when the tire is mounted on a wheel and the wheel is mounted on the vehicle.

“Innerliner” means the layer or layers of elastomer or other material that form the inside surface of a tubeless tire and that contain the inflating fluid within the tire.

“Lateral” means an axial direction.

“Lateral edges” means a line tangent to the axially outermost tread contact patch or footprint as measured under normal load and tire inflation, the lines being parallel to the equatorial centerplane.

“Outboard side” means the side of the tire farthest away from the vehicle when the tire is mounted on a wheel and the wheel is mounted on the vehicle.

“Radial” and “radially” mean lines or directions that are perpendicular to the axis of rotation of the tire.

“Radially inward” and “radially inwardly” refer to a radial direction that is toward the central axis of rotation of the tire.

“Radially outward” and “radially outwardly” refer to a radial direction that is away from the central axis of rotation of the tire.

“TPMS” means a tire pressure monitoring system, which is an electronic system that measures the internal pressure of a tire and is capable of communicating the pressure to a processor that is mounted on the vehicle and/or is in electronic communication with electronic systems of the vehicle.

“Tread element” or “traction element” means a rib or a block element defined by a shape having adjacent grooves.

### DETAILED DESCRIPTION

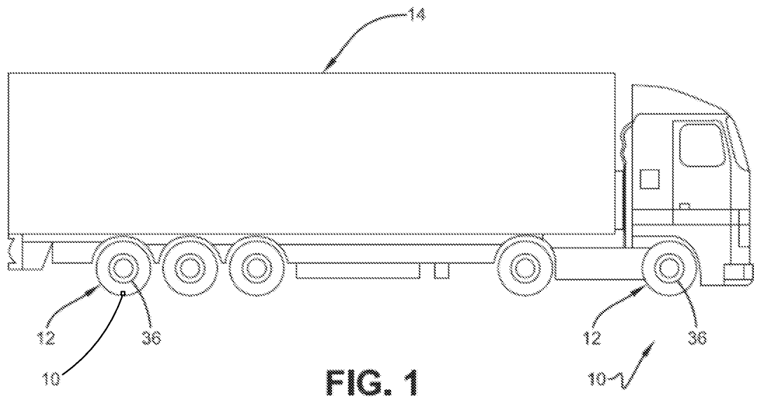

With particular reference to FIG. 1, the tire with a tread wear sensor plug 10 in a tire 12 that provides a system for indicating the wear on the tire 12 supporting a vehicle 14. According to various embodiments, each one of the tires 12 on the vehicle 14 may include one or more of the tread wear sensor plugs 10. While the vehicle 14 is depicted as a commercial truck, the present disclosure is not to be so restricted. To this end, the vehicle 14 may comprise other vehicles falling into various categories such as passenger vehicles, off-the-road vehicles and the like, in which such vehicles are supported by more or fewer tires than shown in FIG. 1.

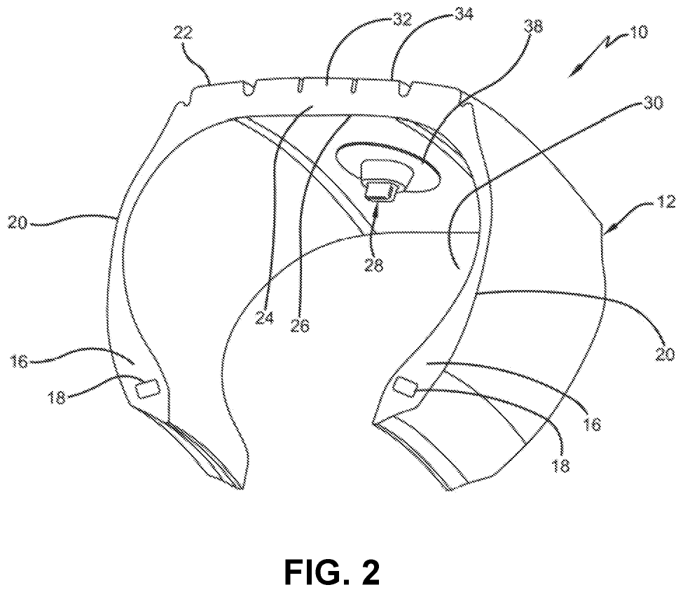

Turning to FIG. 2, shown is a cross sectional view of the tire 12 according to various embodiments. The tire 12 includes a pair of bead areas 16, each one of which is formed with a bead core 18 that is embedded in the respective bead areas. Each one of a pair of sidewalls 20 extends radially outwardly from a respective bead area 16 to a ground-contacting tread 22. The tread 22 is formed with multiple tread elements or tread blocks 32 and defines a radially outer surface 34. The tire 12 is reinforced by a carcass 24 that toroidally extends from one bead area 16 to the other bead area. An innerliner 26 is formed on the inner or inside surface of the carcass 24. The tire 12 is mounted on the flange of a wheel or rim 36 (FIG. 1) forming an internal cavity 30.

According to one embodiment, a sensor unit 28 is mounted to the tire 12. The sensor unit 28 detects certain real-time parameters of the tire 12, and preferably includes a pressure sensor to sense the inflation pressure within a cavity 30 of the tire 12, and a temperature sensor to sense the temperature of the tire 12 and/or the temperature in the cavity 30 of the tire 12. The sensor unit 28 may be a commercially-available tire pressure monitoring system (TPMS) module or sensing unit.

The sensor unit 28 comprises a processor and memory to store tire identification (ID) information for each specific tire 12. For example, the tire ID may include manufacturing information for the tire 12, including the tire model; size information, such as rim size, width, and outer diameter; manufacturing location; manufacturing date; a treadcap code that includes or correlates to a compound identification; a mold code that includes or correlates to a tread structure identification, or other information. The tire ID may also include a service history or other information to identify specific features and parameters of each tire 12.

The sensor unit 28 further includes an antenna for wirelessly transmitting 40 (FIG. 8) measured parameters and tire ID data to a remote processor for analysis, such as a processor integrated into a vehicle electronic control unit and/or a Controller Area Network (CAN) bus associated with the vehicle 14 (FIG. 1).

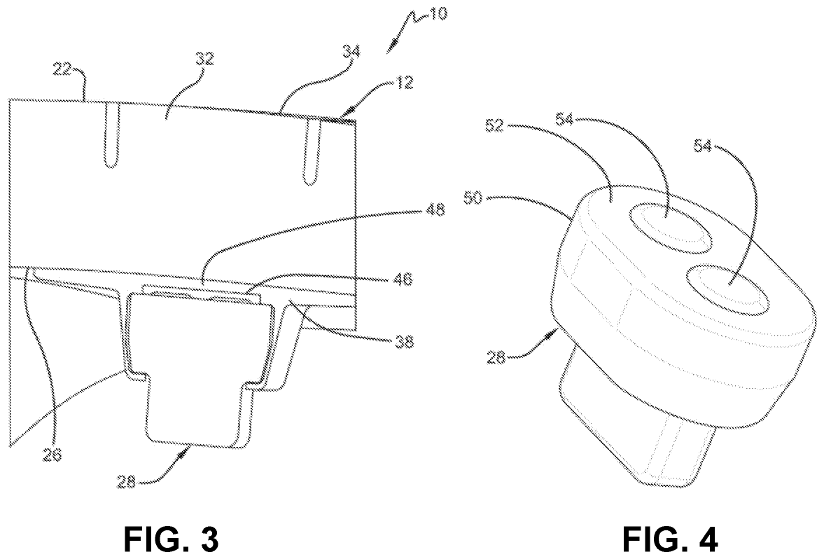

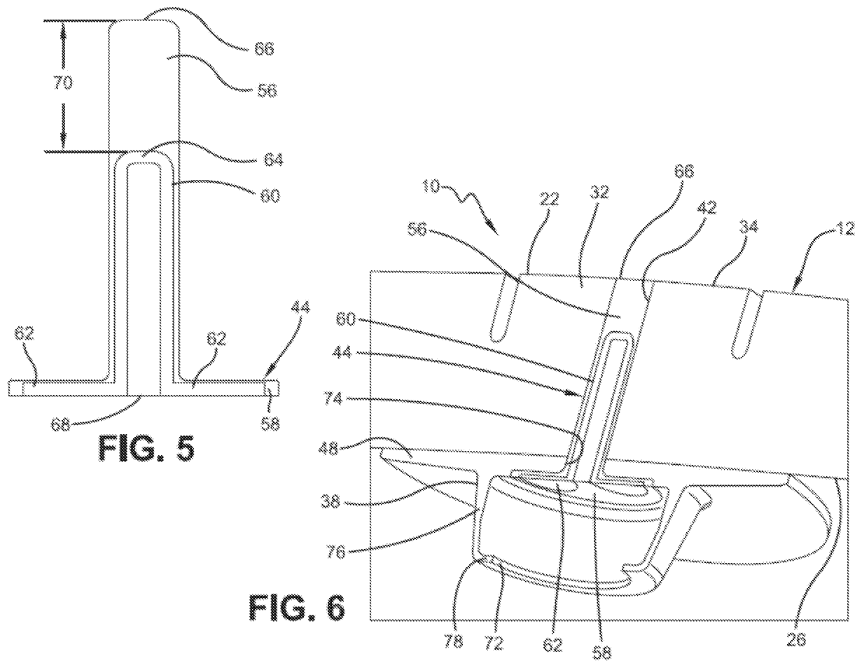

Turning to FIG. 3, the sensor unit 28 may be mounted to the tire 12 using a container 38, which receives the sensor unit 28 and is attached to the innerliner 26 by an adhesive, although the sensor unit 28 may be attached in some other manner or may be integrally molded as part of the innerliner 26 of the tire 12. Preferably, the container 38 is flexible and is formed of an elastomer or polymer. The sensor unit 28 may be attached to the tire 12 before a channel 42 (FIG. 6) for a tread wear sensor plug 44 (FIG. 5) is formed in a selected tread element 32. In such a case, a removable spacer 46 preferably is disposed between the sensor unit 28 and a base 48 of the container 38, which seats against the innerliner 26. The spacer 46 enables insertion of the tread wear plug 44, as will be described in greater detail below. As shown in FIG. 4, the sensor unit 28 includes a rigid housing 50 formed with a base 52. A pair of electrical contacts 54 are mounted on the base 52 and extend through the housing 50.

Referring to FIG. 5, the tread wear plug 44 includes a shaft 56 and a flange 58. According to one embodiment, the shaft 56 is cylindrical in shape although a cross section of the shaft 56 may be rectangular, hexagonal, octagonal, triangular, or any other shape or form. The flange 58 extends outwardly from an end of the shaft 56 to provide a base for the tread wear plug 44. A conductive wire 60 is disposed in the tread wear plug 44. The wire 60 preferably is an insulated wire, but may be an uninsulated wire, depending on particular design considerations. The wire is formed in a U-shape and thus has proximal ends 62 in the flange 58 and a distal end 64 near a radially outer surface 66 of the shaft 56. The proximal ends 62 of the wire 60 extend to contacts at a bottom 68 or exposed end of the flange 58 and allow the tread wear plug 44 to contact the electrical contacts 54 (FIG. 4) of the sensor unit 28, as will be described below. The distal end 64 of the wire 60 is a set distance 70 below the radially outer surface 66 of the shaft 56.

According to one embodiment, an elastomeric connector may be positioned between the proximal ends 62 of the wire 60 and the electrical contacts 54 to ensure a reliable electrical connection therebetween over time. Such elastomeric connectors are generally commercially available. Alternatively, an elastomeric connector may be employed to electrically couple some other electrical contacts associated with the sensor unit 28 other than the electrical contacts 54 to the proximal ends 62. For example, various points on a circuit board that makes up part of the sensor unit 28 may be electrically coupled to the proximal ends 62 by way of an elastomeric connector. Such elastomeric connector may be compressed between various electrical contact points regardless of the material from which such electrical contact points are constructed. For example, the materials may comprise metal, carbon fiber, conductive rubber compositions, or other materials. In the case of carbon fiber, the analytical estimation of electrical resistance is noted in the graph below.

| | |
|---|---|
| Plain | Nickel-coated |
| Carbon Fiber | Carbon Fiber |

| | | | | |
|---|---|---|---|---|
| Individual Carbon Fiber | 300-600 | Ω/mm | 6 | Ω/mm |
| Bundle or composite | 0.3-0.6 | Ω/mm | 6 | mΩ/mm |
| (1,000 filaments) | | | | |
| Bundle or composite | 30-60 | Ω/mm | 0.6 | mΩ/mm |
| (10,000 filaments) | | | | |

Turning to FIG. 6, a channel 42 for the tread wear plug 44 is formed in a selected tread element 32. The container 38 is formed with a sensor unit opening 72, which enables the sensor unit 28 to be removed from the container and thus removably mounted to the tire 12. An opening 74 is formed in the container base 48 in alignment with the channel 42 in the tread element 32. The aligned channel 42 and opening 74 pass radially from an inner surface of the internal cavity 30 of the tire 12 to the radially outer surface 34 of the tread 22. The channel 42 and opening 74 may be formed by drilling, water jet cutting, laser cutting, and or other method.

The tread wear plug 44 is installed in the tire 12 before the tire 12 is mounted on the wheel 36. The shaft 56 of the tread wear plug 44 is inserted from the direction of the cavity 30 through the aligned container opening 74 and into the channel 42 in the tread element 32. The shaft 56 extends through the channel 42 in the tread element 32, with the shaft outer surface 66 being flush with the outer surface 34 of the tread element 32. Preferably, the shaft 56 is formed of a material that includes mechanical properties, such as shear modulus, which are similar to those of the material of the tread 22. Such similarity ensures that there are no rigid components within the structure of the tire 12, thereby enabling the shaft 56 of the tread wear plug 44 to behave like a compatible plug in the tread element 32.

The flange 58 of the tread wear plug 44 preferably is of an elastomeric material that is compatible with the container 38. Once the shaft 56 is inserted into the container base opening 74 and the channel 42, the flange 58 engages the base 48 of the container 38 to provide a positive mechanical stop for the tread wear plug 44. The flange 58 also provides a seal about the container base opening 74 to prevent air flow from the tire cavity 30 out through the opening 74 and the channel 42.

Once the tread wear plug 44 is seated through the aligned container opening 74 and into the channel 42, and the flange 58 seats against the container base 48, the sensor unit 28 is reinstalled. The sensor unit 28 is inserted into the container 38 through the sensor unit opening 72. Because the container 38 is formed of a flexible material, a wall 76 and lip 78 flex to allow insertion of the sensor unit 28, and then secure the sensor unit in the container 38. The sensor unit 28 is rotated to enable each sensor electrical contact 54 to contact a respective proximal end 62 of the plug wire 60.

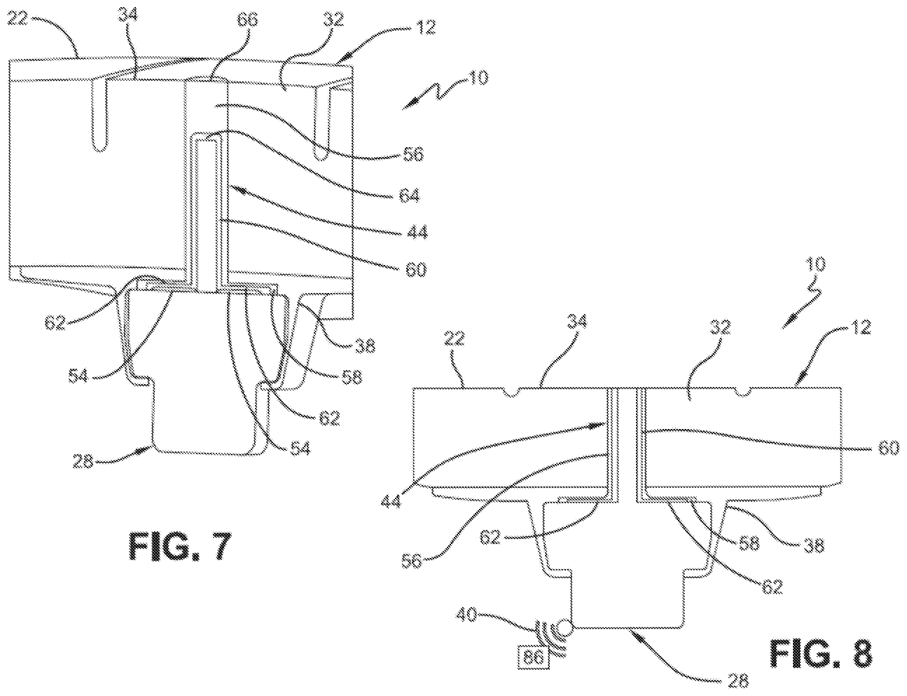

Turning to FIGS. 7 and 8, operation of the tire with a tread wear plug 10 is shown. With particular reference to FIG. 7, the tread wear plug 44 is installed in the tire 12, and the shaft outer surface 66 is flush with the tread element outer surface 34. A continuous electrical circuit is formed by the wire 60 and the contact of each proximal wire end 62 with each respective electrical contact 54 of the sensor unit 28. The distal end 64 of the wire 60 is disposed at a predetermined distance 70 (FIG. 5) below the radially outer surface 66 of the shaft 56, which corresponds to a minimum recommended tread depth.

Referring to FIG. 8, as the tread 22 wears, the shaft 56 of the wear plug 44 also wears. When the tread 22 and the shaft 56 wear down to the wire 60, the distal end 64 of the wire 60 breaks, creating a break in the electrical circuit formed by the wire and the contact of each proximal wire end 62 with each respective sensor unit electrical contact 54. The sensor unit 28 senses the break in the electrical circuit, and wirelessly transmits 40 a notice 86 that the electrical circuit has broken and/or that a predefined minimum tread depth has been reached. The predefined minimum tread depth comprises a minimum recommended tread depth of the tire 12. The notice 86 transmitted 40 by the sensor unit 28 may be sent to a remote processor, such as a processor that is integrated into a vehicle electronic control unit, CAN bus, and/or a cloud-based server. The notice 86, by communicating that the minimum tread depth has been reached, thus indicates when replacement or retreading of the tire 12 should take place.

In this manner, the tire with a tread wear plug 10 indicates tire wear with components that are mounted within the tire 12 and does not require sensors that are external to the tire. The tire 12 with a tread wear plug 10 provides a direct wear sensor system for a vehicle tire 12 that includes a structure which is easy to install in the tire 12, withstands the operating environment of the tire 12, accurately indicates tire wear in a repeatable manner, and is capable of transmitting a wear indication to an electronic control system of the vehicle 14.

The present disclosure also includes a method of determining wear of a tire using a tread wear sensor plug 10, and a method of forming a tire with a tread wear sensor plug 10 for indicating tread depth. Each method includes steps in accordance with the description that is presented above and shown in FIGS. 1 through 8.

It is to be understood that the structure of the above-described tire with a tread wear plug 10 may be altered or rearranged, or components or steps known to those skilled in the art omitted or added, without affecting the overall concept or operation of the various embodiments. For example, a single tread wear plug 44 may be disposed in the tread 22 of the tire 12, or multiple tread wear plugs may be disposed in the tread about the tire. In addition, the tread wear plug 44 may be inserted into the tread element 32 before or after curing of the tire 12. Furthermore, the tread wear plug 44 may include multiple wires 60, each one having a distal end 64 spaced apart from the other wires, which enables the tread wear plug to indicate different wear states of the tread 22, without affecting the overall concept or operation of the various embodiments.

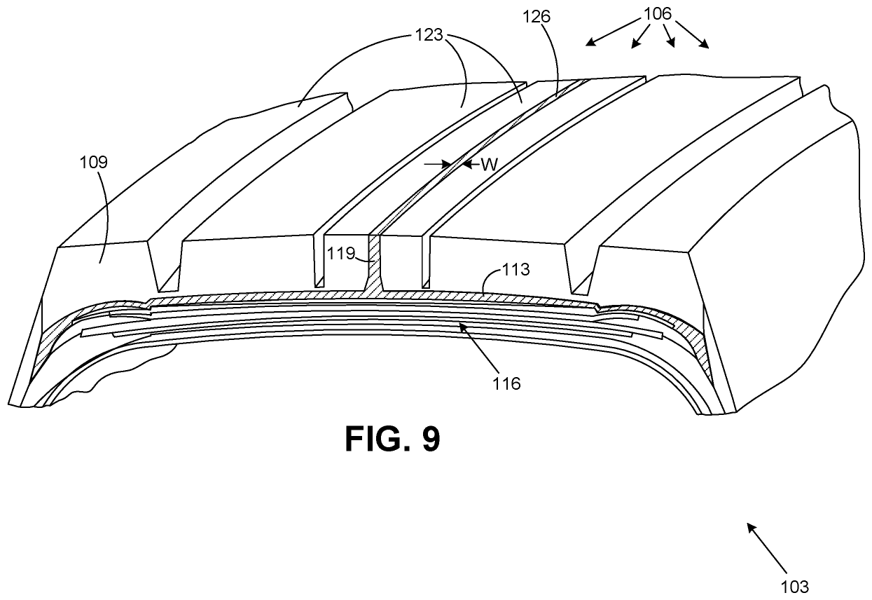

Referring next to FIG. 9, shown is a cross sectional view of a portion of a tire 103 according to various embodiments. The tire 103 includes a tread 106 comprising multiple tread elements 109. The tread 106 is positioned adjacent to, and radially outward relative to, an undertread 113. The tire 103 includes a pair of sidewalls 20 (FIG. 2), where each one of the sidewalls 20 extend radially outwardly from a respective bead to the tread 106. The tire 103 also includes a belt package 116 positioned radially inwardly relative to the undertread 113. The tire 103 includes a carcass with an innerliner and other components as can be appreciated.

The tire 103 also includes a chimney 119 that extends from the undertread 113 to the radially outer surface 123 of the tire 103 defined by the tread 106. The chimney 119 includes a chimney outer surface 126 that is generally flush with the radially outer surface 123 of the tire 103 and respective tread elements 106 in which the chimney 119 is disposed. Although the chimney 119 is shown in FIG. 9 as positioned within a single tread element 106, it is understood that the chimney 119 may run through multiple tread elements 106.

Various tires 103 are manufactured with the goal of achieving a predefined resistance from the hub upon which a tire 103 is installed to the ground. To measure the resistance of a given tire 103, the tire 103 may be installed on a test hub and the tire 103 may be placed on a metal plate under load at a predefined internal pressure and a desired temperature. The resistance presented by the tire may be measured from the hub to the metal plate upon which the tire 103 is placed. For some applications, a higher value of resistance is acceptable where such tires may include a resistance of less than 10 MΩ or other appropriate resistance value. For certain applications such as vehicles that haul flammable materials, it may be desirable that the resistance of a given tire to ground may be less than 1 MΩ. These resistances are noted herein as the tire resistance.

In one embodiment, the undertread 113 is constructed from a rubber material which provides for a degree of conductivity. To this end, the undertread 113 may be constructed from the materials that provide for a tire resistance of less than 10 MΩ, 1 MΩ, or other desired tire resistance as mentioned above. Given the fact that the undertread 113 is conductive, electrical current is able to flow through such material. The undertread 113 is electrically coupled to the metal hub upon which the tire 103 is mounted through conductive elements of the sidewalls 20 (FIG. 2) and other components of the tire 103 as can be appreciated.

The chimney 119 may be constructed from a conductive rubber composition. The conductive rubber composition comprises, for example, a rubber component and one or more electrically conductive carbon components. The conductive rubber composition has an uncured or cured electrical resistance at 23° C. less than about 10KΩ when formed into a wire about 10 inches (254 mm) long and 2 mm in diameter. Given these parameters, various actual measurements of the resistance of such conductive rubber compositions include 1.3 KΩ, 4.4 KΩ, and 5.5 KΩ. According to one embodiment, the resistivity of the chimney 119 is much less than the resistivity of the undertread 113. For example, the resistivity of such conductive rubber composition may be, for example, about 7.7 Ohm-centimeters or other value of a similar order as compared to materials that might have a resistivity be below 7.0×10⁵ Ohm-centimeters. As an alternative, the resistivity of an acceptable rubber composition may have a resistivity that is one or two more orders of magnitude greater than 7.7×10¹ Ohm-centimeters as can be appreciated.

When the tire 103 is installed on a vehicle, the chimney 119 establishes a conductive pathway from the conductive undertread 113 to the ground upon which the vehicle travels. In this respect, the ground includes all elements upon which a vehicle may travel including pavement, cement, steel (bridges) dirt, rocks, or any other elements as can appreciated. As such, the term ground as contemplated herein refers to an electrical ground as well as a physical ground upon which a vehicle rests. The tire 103 includes a conductive pathway established with conductive materials from the hubs of a vehicle through the sidewalls 20 to the undertread 113. The chimney 119 completes the circuit by providing a conductive pathway from the undertread 113 to the terrestrial medium upon which the vehicle travels.

As a given vehicle travels, it is common to acquire a static charge relative to ground. The chimney 119 provides a conductive pathway through the tread 106 through which such a static charge can be discharged to ground. This prevents the buildup of large static charges in the vehicle relative to the ground.

A lateral width W of the chimney 119 is specified to provide for a predetermined minimum chimney outer surface area in the footprint of the tire 103. This minimum surface area provides for a pathway from the undertread 113 to ground for effective discharge of an electrostatic charge that builds up in the vehicle relative to the ground. The actual width W of the chimney 119 will depend upon the desired tire resistance as will be described.

The lateral position of the chimney 119 may vary depending on the locations of the tread elements 109 of a given tire 103. In one embodiment, the chimney 119 is located at a lateral position on the tread 106 so as to maximize the contact between the outer surface of the chimney 119 and the ground. In one embodiment, the chimney 119 may be positioned so that a center of the chimney 119 coincides with an equatorial plane of the tire 103.

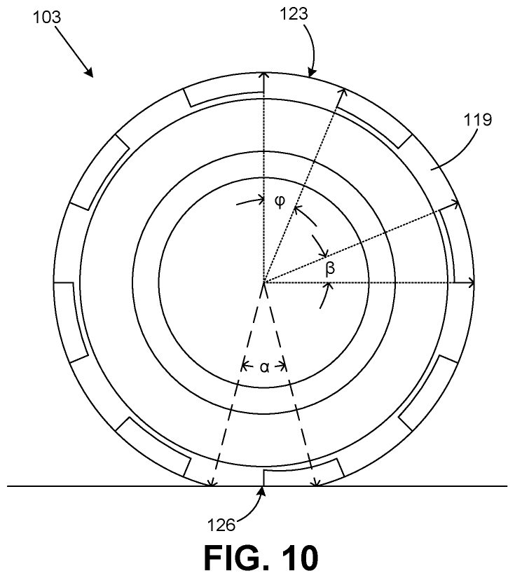

Referring next to FIG. 10, shown is a partial side cutaway view of the tire 103 according to various embodiments. As shown, in one example embodiment, the chimney 119 comprises an annular chimney that extends circumferentially 360 degrees around the entire periphery of the tire 103. In this manner, at least a portion of an annular chimney is always within a footprint 126 of the tire 103, thereby establishing constant and uninterrupted contact with the ground.

In an alternative embodiment, the chimney 119 may extend circumferentially around at least a portion of the tread 106. In this respect, as shown in FIG. 10, angular sections noted by angle φ in which the chimney 119 extends from the undertread 113 to the radially outer surface 123 of the tire 103. Between the sections where the chimney 119 so extends are angular voids noted by angle β in which the chimney 119 is omitted. In addition, a further angle α is defined by the edges of the footprint 126 that provide a maximum circumferential distance across the footprint 126 of the tire 103. According to one embodiment, the angle φ of the angular voids between the angular sections of the chimney 119 is less than the angle α of the maximum circumferential distance of the footprint 126 of the tire 103. This ensures that an electrical pathway between the undertread 113 and ground through the chimney 119 is continuous with the rotation of the tire 103. To manufacture a tire 103 having a chimney 119 that is exposed at the radially outer surface 123 intermittently as opposed to a full circumference around the tire 103, an uncured split tread may be mated with a center chimney section that alternates between respective materials to create the angular sections noted by angle φ in which the chimney 119 extends from the undertread 113.

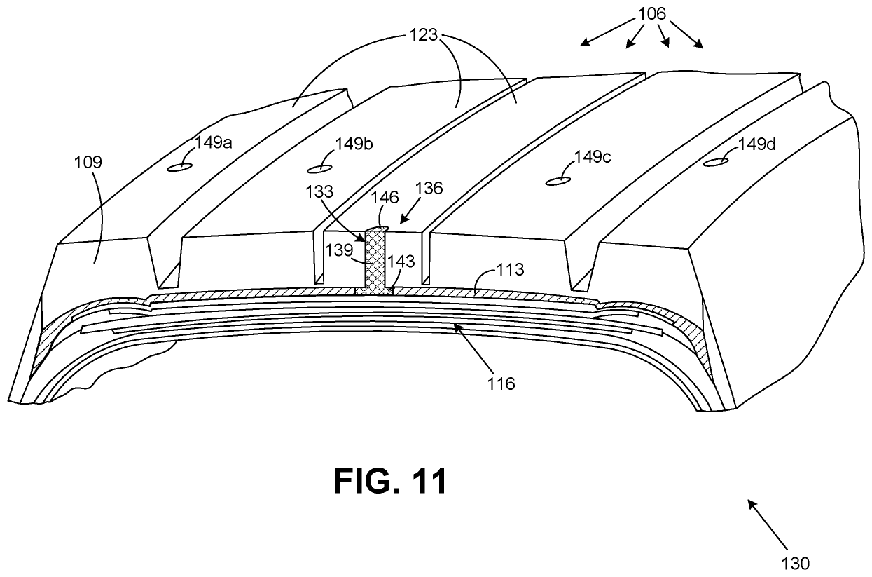

With reference to FIG. 11, shown is a cross sectional view of a portion of a tire 130 according to various embodiments. The tire 130 is similar to the tire 103, where components that both embodiments have in common are indicated using the same reference numbers. The tire 130 includes a channel 133 that extends through a tread element 109 of the tread 106.

The tire 130 includes a conductive insert 136 that comprises a shaft 139 that includes a flange 143 at one end. The flange 143 extends outwardly from the end of the shaft 139 to provide a base for the conductive insert 136. The conductive insert 136 is placed into the channel 133 such that an outer surface 146 of the shaft 139 is flush with the radially outer surface 123 of a respective tread element 109. In this manner, the conductive insert 136 extends from the undertread 113 through the channel to the radially outer surface 123 of a respective tread element 109 of the tread 106. As such, the radially outermost surface of the conductive insert 136 is flush with the outer surface of a respective tread element 109 of the tread 106. The tire 130 includes a pair of sidewalls 20 (FIG. 2), where each one of the sidewalls 20 extend radially outwardly from a respective bead to the tread 106.

As was described above, the undertread 113 is constructed from a material that provides for a degree of conductivity to allow electrical current to flow through such material. This makes the undertread 113 a conductive component of the tire 130. The undertread 113 is positioned radially inward relative to the radially outer surface 123 of the tread 106. The undertread 113 is electrically coupled to the metal hub upon which the tire 130 is mounted through conductive elements of the sidewalls 20 and other components of the tire 103 as can be appreciated.

According to one embodiment, the conductive insert 136 is constructed from a conductive rubber composition. As mentioned above, the conductive rubber composition comprises, for example, a rubber component and one or more electrically conductive carbon components. The conductive rubber composition has an uncured or cured electrical resistance at 23° C. less than about 10KΩ when formed into a wire about 10 inches (254 mm) long and 2 mm in diameter. Given these parameters, various actual measurements of the resistance of such conductive rubber compositions include 1.3 KΩ, 4.4 KΩ, and 5.5 KΩ. Consequently, the resistivity of the conductive insert 136 is much less than the resistivity of the undertread 113. For example, the resistivity of such conductive rubber composition may be, for example, about 7.7 Ohm-centimeters or other value of a similar order as compared to materials that might have a resistivity be below 7.0×10⁵ Ohm-centimeters. As an alternative, the resistivity of an acceptable rubber composition may have a resistivity that is one or two more orders of magnitude greater than 7.7×10¹ Ohm-centimeters as can be appreciated.

The flange 143 of the conductive insert 136 is positioned so as to come into contact with the material of the undertread 143. In one embodiment, the flange 143 displaces a portion of the undertread 143. By virtue of the contact between the flange 143 and the undertread 143, the conductive insert 136 establishes an electrical pathway from the undertread 113 to the radially outer surface 123 of the tread 106.

To construct the tire 130 with the conductive insert 136, the channel 133 may be formed in a respective tread element 109 before or after the tread 106 has been cured and placed on the tire 130 during assembly. Also, a void shaped like the flange 143 is created in the undertread 113 to accommodate the flange 143. A center axis of the void is in alignment with a center axis of the channel 133 through the respective tread element 109 so as to accommodate the entire conductive insert 136.

When placed in the tread 106 of the tire 130, the conductive insert 136 establishes a conductive pathway from the conductive undertread 113 to the ground upon which the vehicle travels. Given that the tire 103 includes a conductive pathway established with conductive materials from the hubs of a vehicle through the sidewalls 20 to the undertread 113, the conductive insert 136 completes the circuit by providing a conductive pathway from the undertread 113 to the ground upon which the vehicle travels when the conductive insert 136 falls within the footprint of the tire 130. In this manner, the conductive insert 136 facilitates the discharge of a static charge that builds up in the vehicle relative to the ground as the vehicle travels in a manner similar to the chimney 119 (FIG. 9) discussed above.

To ensure that an electrostatic charge of at least a predefined magnitude is discharged to ground through the conductive insert 136, the size and shape of the shaft 139 may be specified so that the radially outer surface of the conductive insert 136 is large enough such that the ultimate resistance presented by the conductive insert 136 is low enough to facilitate a satisfactory discharge to ground.

The conductive insert 136 may be placed at any position where a tread element 109 exists on the tread 106. That is to say that the conductive insert 136 may be located at any position laterally on the tread 106 with the exception that there must be space for the flange 143 relative to a side edge of the undertread 113 if the conductive insert 136 is placed near an edge of the tread 106. As an illustration, the conductive insert 136 may be placed at positions 149a-d.

In addition, a plurality of conductive inserts 136 may be included in a single tire 130. In such case, each individual one of such conductive inserts 136 may be placed at various positions on a given tread 106 of the tire 130.

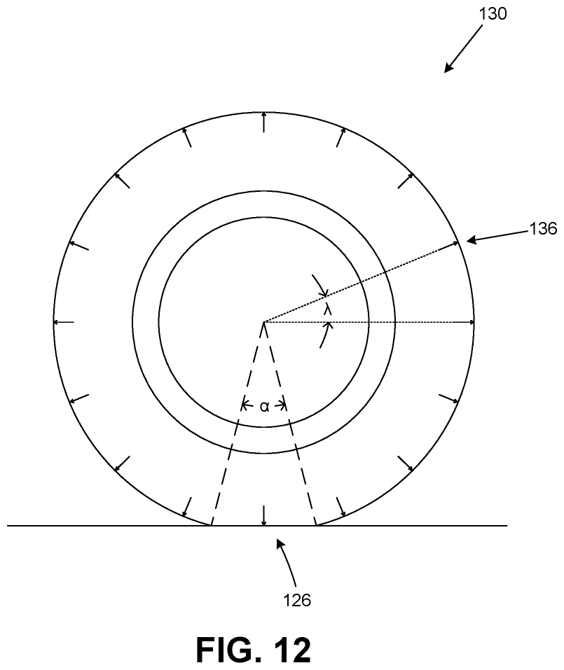

Referring next to FIG. 12, shown is a partial side cutaway view of the tire 130 according to various embodiments. In one embodiment, the conductive inserts 136 are positioned circumferentially around the tread 106 at even intervals. As shown in FIG. 12, an angle A is defined between any two adjacent conductive inserts 136. Also, an angle α is defined by the edges of the footprint 126 that provide a minimum circumferential distance across the footprint 126 of the tire 103. According to one embodiment, the angle A is less than the angle α so as to ensure that one of the conductive inserts 136 falls within the footprint at any given time. This ensures that constant and uninterrupted electrical contact is maintained between the undertread 113 (FIG. 11) and the ground through a respective one of the conductive inserts 136.

It is understood that in some embodiments, it is not necessary that at least one conductive insert 136 falls within the footprint at any given time. That is to say, a lesser number of conductive inserts 136 may be employed where acceptable electrostatic discharge is accomplished when a given conductive insert 136 falls within the footprint of a tire 103 as the tire 103 rotates, where a period of time exists between when a given conductive insert 136 leaves the footprint and another conductive insert 136 enters the footprint. Indeed, in one embodiment, a given tire 103 may only include a single conductive insert 136 and electrostatic discharge may substantially occur once each revolution of the tire 103 when such conductive insert 136 falls into the footprint of a tire 103. As such, the conductive inserts 103 may be used to establish intermittent contact between inner conductive elements of the tire 103 and the ground.

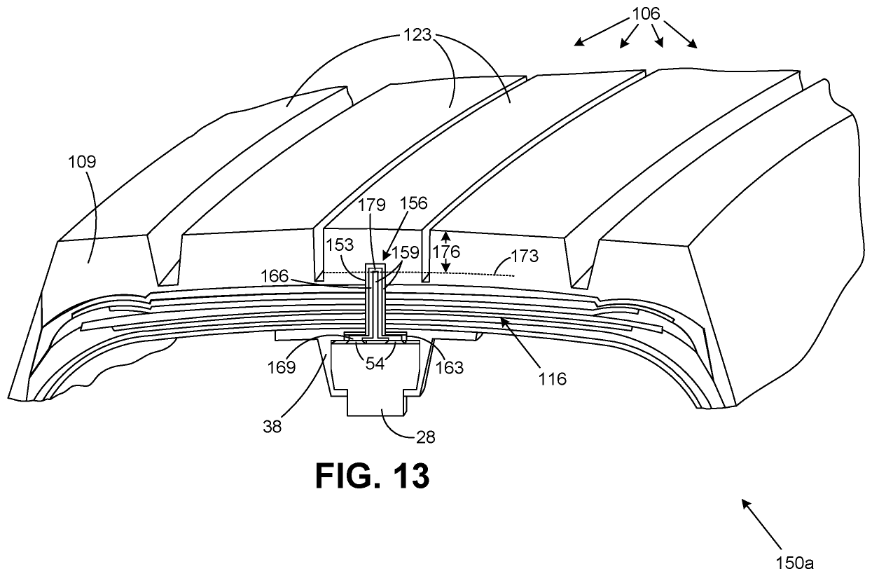

Turning then to FIG. 13, shown is a cross sectional view of a portion of a tire 150a according to various embodiments. The tire 150a is similar to the tire 103, where components that both tires 103 and 150a have in common are indicated using the same reference numbers. Thus, the tire 150a includes a tread 106 comprising multiple tread elements 109. The tread 106 is positioned adjacent to, and radially outward relative to, an undertread 113. The tire 150a includes a pair of sidewalls 20 (FIG. 2), where each one of the sidewalls 20 extend radially outwardly from a respective bead to the tread 106. The tire 103 also includes a belt package 116 positioned radially inwardly relative to the undertread 113. The tire 150a also includes a carcass with an innerliner and other components as can be appreciated.

In addition, the tire 150a includes a channel 153 that extends from an inside surface of the tire 150a through a least a portion of one of the tread elements 109. A tread wear plug 156 having a shaft 159 is positioned in the channel 153. A flange 163 extends outwardly from one end of the shaft 159 to provide a base for the tread wear plug 156.

The tire 150a includes the sensor unit 28 that is held in the container 38 as was discussed with respect to FIGS. 1-8 above.

The tread wear plug 156 further includes a conductor 166 embedded in the shaft 159. Each of the ends of the conductor 166 terminate into a corresponding sensor contact 169 in the flange 163. Each sensor contact 169 is exposed on an open end of the flange 163. The conductor 166 and the sensor contacts 169 are constructed from the conductive rubber composition. Alternatively, the conductor 166 and sensor contacts 169 may be constructed from carbon fiber or other material with similar properties.

As mentioned above, the conductive rubber composition comprises, for example, a rubber component and one or more electrically conductive carbon components. The conductive rubber composition has an uncured or cured electrical resistance at 23° C. less than about 10KΩ when formed into a wire about 10 inches (254 mm) long and 2 mm in diameter. Given these parameters, various actual measurements of the resistance of such conductive rubber compositions include 1.3 KΩ, 4.4 KΩ, and 5.5 KΩ. The resistivity of such conductive rubber composition may be, for example, about 7.7 Ohm-centimeters or other value of a similar order as compared to materials that might have a resistivity be below 7.0×10⁵ Ohm-centimeters. As an alternative, the resistivity of an acceptable rubber composition may have a resistivity that is one or two more orders of magnitude greater than 7.7×10¹ Ohm-centimeters as can be appreciated.

The portion of the shaft 159 in which the conductor 166 is embedded is constructed from a material with properties similar to the properties of the tread 106 of the tire 150a. In one embodiment, this material is nonconductive to electrically isolate the conductor 166 from other portions of the tire 150a such as the belt package 116. Alternatively, the material of the shaft 159 may have a very high resistivity as compared to the resistivity of the conductor 166 such that the material will not interfere with the ability to detect a lack of continuity in the conductor 166 as will be described. The material may comprise any one of various rubber compositions having suitable characteristics for use in the tire 150a.

The tire 150a includes a predefined minimum tread depth 173. As a tire 150a is put into service on a vehicle over time, the tread 106 will wear down. The predefined minimum tread depth 173 is a minimum recommended tread depth at which the tire 150a can be placed into service. Once the tread 106 wears below the predefined minimum tread depth 173, then the tire 150a should be taken out of service. The tread 106 of the tire 150a thus includes a sacrificial portion 176 that is expected to wear away over time while the tire 150a is in service. The conductor 166 includes a radially outermost portion 179 that is positioned at a predefined depth with respect to the outer surface of the tread element 109 of the tread 106. In one embodiment, this radially outermost portion 179 is positioned within the sacrificial portion 176 of the tread 106 such that when the entire radially outermost portion 179 is worn away, the continuity of the conductor 166 is compromised and detected by the sensor unit 28 as described above.

As such, the radially outermost portion 179 of the conductor 166 may be positioned at any depth in the tread 106 so as to detect wear of the tread 106 at various heights. In one embodiment, the radially outermost portion 179 of the conductor 166 is positioned relative to the predefined minimum tread depth 173 such that when the radially outermost portion 179 of the conductor 166 has worn away, the tread 106 will have been worn down to the predefined minimum tread depth 173. The sensor unit 28 can thus detect when the tire 150a has reached maximum wear and should be taken out of service.

As was mentioned above, the sensor unit 28 includes a pair of electrical contacts 54 that are mounted on the base 52 (FIG. 4) and extend through the housing 50 (FIG. 4). The sensor unit 28 comprises an electrically active sensor as described above. According to one embodiment, each of the electrical contacts 54 are in direct contact with a corresponding one of the sensor contacts 169 in the tread wear plug 156. Given that the sensor contacts 169 exposed on the open end of the flange 163 are constructed from the conductive rubber composite material, the flexibility of the material ensures solid electrical contact between the sensor contacts 169 of the tread wear plug 156 and the electrical contacts 54 of the sensor unit 28. In one embodiment, the sensor unit 28 is held by the container 38 such that the electrical contacts 54 are pressed or driven into the sensor contacts 169 to ensure that electrical contact between the electrical contacts 54 and the sensor contacts 169, respectively, is maintained while the tire 150a is in service.

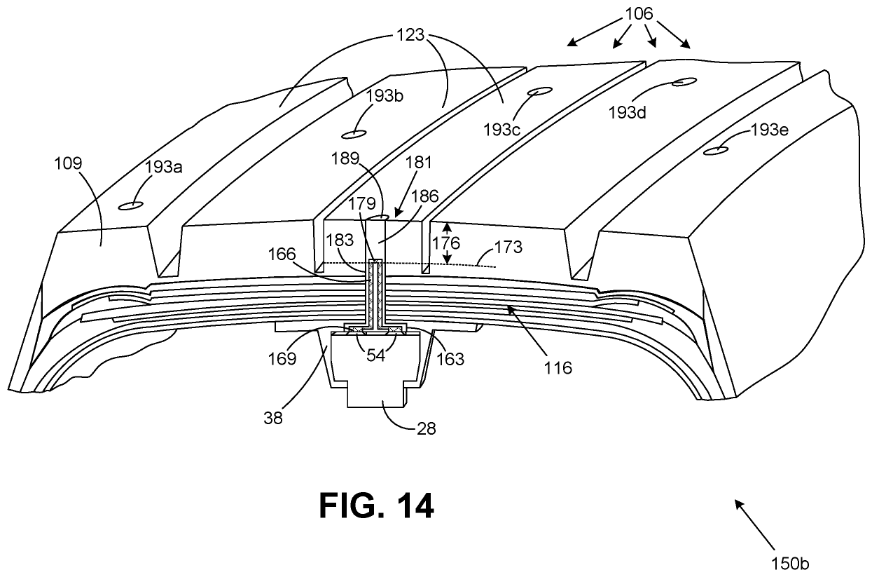

Referring next to FIG. 14, shown is a cross sectional view of a portion of a tire 150b according to various embodiments. The tire 150b is essentially the same as the tire 150a (FIG. 13), where reference numbers for like components are the same for both figures. The tire 150b is essentially the same as the tire 150a except for the fact that the channel 183 extends from the inside surface of the tire 150b to a radially outer surface 123 of a respective one of the tread elements 109 of the tread 106. Also, the shaft 186 of the tread wear plug 181 extends through the entire channel 183 such that the radially outermost surface 189 of the shaft 186 is flush with the radially outermost surface 123 of a given tread element 109 of the tread 106. To the extent that tread elements 109 may vary in height, the radially outermost surface 189 is flush with the radially outermost surface of a tread element 109 into which the tread wear plug 181 is disposed.

In addition, with respect to FIGS. 13 and 14, the tread wear plugs 156 or 181 may be located at any lateral position on the tread 106 of the tire 150a/150b. For example, the tread wear plug 181 may be placed at positions 193a-e or any other position on the tread 106 in a given tread element 109 as shown. In this manner, the tread wear plugs 156/181 may be positioned to detect tread wear at any lateral location on the tread 106 of a tire 150a/150b. Also, according to various embodiments, the radial outermost portion 179 of the conductor 166 may be positioned at various predefined depths with respect to the radial outer surface 123 of a given tread element 109 to detect different levels of wear of the tread 106. For example, it may be desirable to detect different levels of wear of a tread 106 at different lateral locations on the tread 106.

In one embodiment, a tread wear plug 156/181 may be positioned to intersect an equatorial plane of a tire 150a/150b. Alternatively, a tread wear plug 156/181 may be positioned such that a first distance between a channel 153/183 and a lateral edge of the tread 106 may be greater than a second distance between a channel 153/183 and the equatorial plane of the tire 150a/150b. Also, a distance between the channel 153/183 and an equatorial plane of the tire 150a/150b may be greater than a distance between the channel 153/183 and a lateral edge of the tread 106.

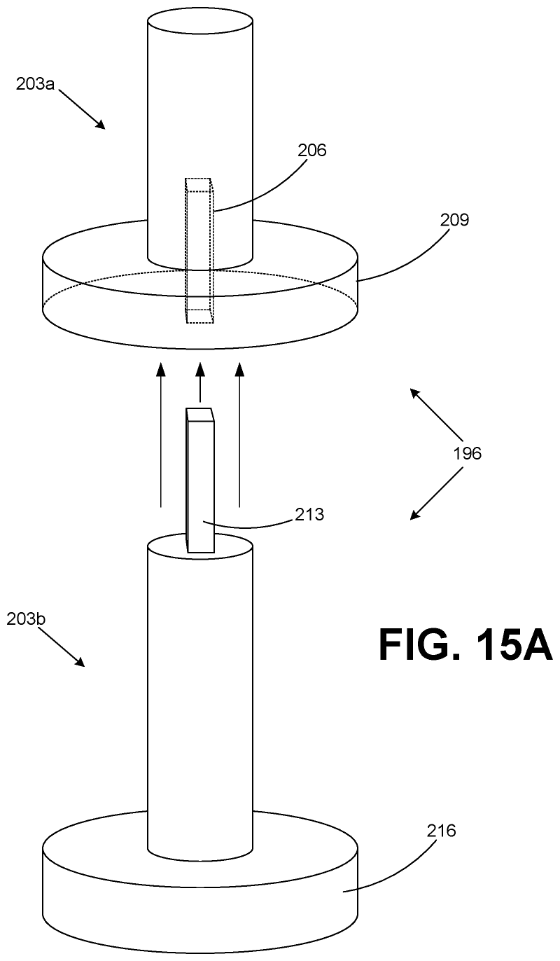

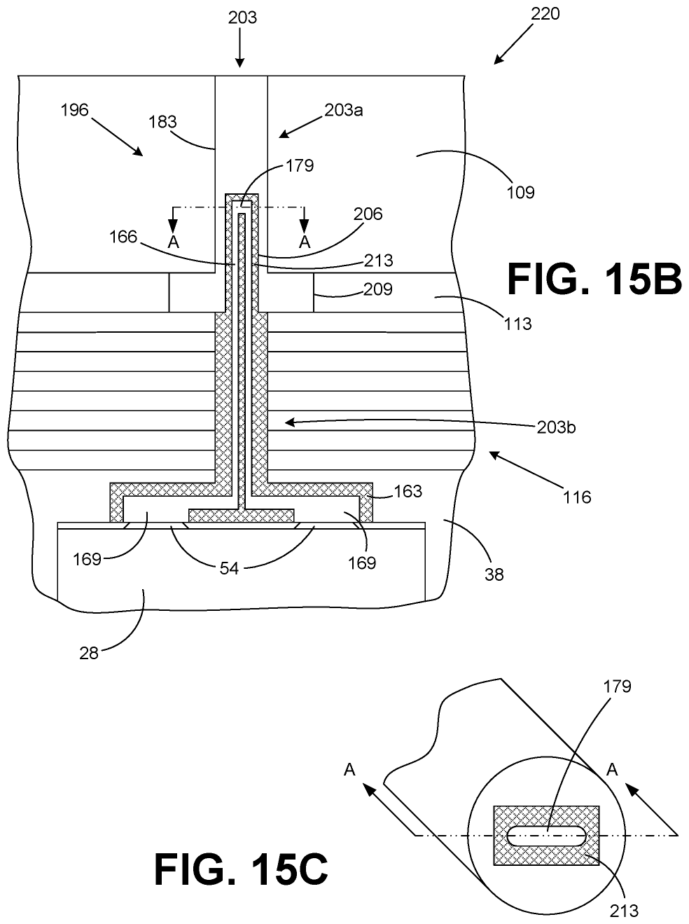

With reference to FIGS. 15A, shown is an exploded view of an example of a tread wear sensor plug 196 that also provides for an electrostatic discharge according to an embodiment of the present disclosure. The tread wear sensor plug 196 includes a shaft 203 that is to be positioned in a channel 183 as will be described. The shaft 203 includes an electrostatic discharge portion 203a and a tread wear sensor portion 203b.

The electrostatic discharge portion 203a of the shaft 203 includes an inner channel 206 that may be shaped so as to receive a portion of the tread wear sensor portion 203b as will be described. Also, in one embodiment, a flange 209 extends from a radially innermost end of the electrostatic discharge portion 203a of the shaft 203. However, in another embodiment, the flange 209 may be omitted.

In one embodiment, the electrostatic discharge portion 203a of the shaft 203 is constructed from the conductive rubber composition which comprises, for example, a rubber component and one or more electrically conductive carbon components. The conductive rubber composition has an uncured or cured electrical resistance at 23° C. less than about 10KΩ when formed into a wire about 10 inches (254 mm) long and 2 mm in diameter.

The tread wear sensor portion 203b includes a tread sensor extension 213 that protrudes from a radially outermost end of the tread wear sensor portion 203b. The tread sensor extension 213 is shaped so as to fit within the inner channel 206 of the electrostatic discharge portion 203a. When the tread sensor extension 213 is positioned in the inner channel 206 of the electrostatic discharge portion 203a, the electrostatic discharge portion 203a and the tread wear sensor portion 203b together comprise the entire shaft 203 of the tread wear sensor plug 196. Also, a flange 163 extends from a radially innermost end of the tread wear sensor portion 203b.

The electrostatic discharge portion 203a may be placed into a portion of the channel 183 that extends through the tread 106 before the tread 106 is applied to a tire 220. In this respect, the tread 106 may be in a cured or uncured state when the electrostatic discharge portion 203a is positioned in the portion of the channel 183 extending through the tread 106. Ultimately, when the tread 106 is placed on the tire 220 during the manufacturing process, the portion of the channel 183 that extends through the tread 106 would be positioned so as to align with the portion of the channel 183 extending through the remaining components of the tire 220 including the undertread 113, belt package 116, inner lining, and potentially other components.

Referring next to FIG. 15B, shown is a cutaway view of a portion of a tire 220 that illustrates the tread wear sensor plug 196 of FIG. 15A placed in a channel 183. The tire 220 includes many of the elements of the tire 150b (FIG. 14), where reference numbers for like components are the same for both structures. The tread wear sensor plug 196 includes the conductor 166 embedded within the tread wear sensor portion 203b. The material of the tread wear sensor portion 203b is constructed from a material with properties similar to the properties of the tread 106 of the tire 220. In one embodiment, this material is nonconductive to electrically isolate the conductor 166 from other portions of the tire 220 such as the belt package 116. Alternatively, the material of the tread wear sensor portion 203b may have a very high resistivity as compared to the resistivity of the conductor 166 such that the material will not interfere with the ability to detect a lack of continuity in the conductor 166. The material may comprise any one of various rubber compositions having suitable characteristics for use in the tire 220.

The tire 200 includes the channel 183 that extends from the inner surface of the tire 200 to the radially outermost surface 123 (FIG. 14) of the tire 200. In this respect, the channel 183 extends through various components such as a belt package 116, the undertread 113, and other components of the tire 200.

The conductor 166 extends into the tread sensor extension 213 such that the radially outermost portion 179 of the conductor 166 is positioned so as to detect a predefined amount of tread wear of the tire 220. As mentioned above, when the tread 106 is worn down to the point of breaking the conductor 166, the sensor unit 28 detects the discontinuity in the conductor 166 and signals that the tread 106 of the tire 166 has reached the minimum level of tread needed for safe vehicle operation. In this manner, an operator of the vehicle is warned that the tire needs to be replaced. Thus, the conductor 166 is embedded within the tread wear sensor portion 203 so as that the point of wear of the tread 106 that triggers the warning to the operator is a point in which the conductor 166 will be worn away such that a discontinuity in the conductor 166 occurs.

In one embodiment, the conductor 166 may comprise the conductive rubber composition which comprises, for example, a rubber component and one or more electrically conductive carbon components. The conductive rubber composition has an uncured or cured electrical resistance at 23° C. less than about 10KΩ when formed into a wire about 10 inches (254 mm) long and 2 mm in diameter. Alternatively, the conductor 166 and sensor contacts 169 may be constructed from carbon fiber or other material with similar properties.

As was described in other embodiments above, the ends of the conductor 166 terminate into sensor contacts 169. Also, the sensor unit 28 includes a pair of electrical contacts 54. The electrical contacts 54 are in direct contact with a corresponding one of the sensor contacts 169 in the tread wear plug 156 as was mentioned above. Given that the sensor contacts 169 exposed on the open end of the flange 163 are constructed from the conductive rubber composite material, the flexibility of the material ensures solid electrical contact between the sensor contacts 169 of the tread wear plug 156 and the electrical contacts 54 of the sensor unit 28. In one embodiment, the sensor unit 28 is held by the container 38 such that the electrical contacts 54 are pressed or driven into the sensor contacts 169 to ensure that electrical contact between the electrical contacts 54 and the sensor contacts 169, respectively, is maintained while the tire 150a is in service.

In addition, the electrostatic discharge portion 203a may or may not include the flange 209. In this respect, the flange 209 is optional. According to one embodiment, the electrostatic discharge portion 203a is in direct contact with, or electrically coupled to, a conductive component such as an undertread 113 of the tire 220. In this respect, if the electrostatic discharge portion 203a includes the flange 209, then it may be the case that the flange 209 comes into contact with the conductive component such as the undertread 113. In the case that the electrostatic discharge portion 203a does not include the flange 209, the shaft portion of the electrostatic discharge portion 203a may be in direct contact with, or electrically coupled to such conductive component such as the undertread 113.

Referring next to FIG. 15C, shown is a cutaway view taken across section line AA depicted in FIG. 15B. As shown, the material of the tread sensor extension 213 surrounds the conductor 166 (FIG. 15B), where section line AA cuts through the center of the radially outermost portion 179 of the conductor 166. As such, the conductor 166 is electrically isolated from the electrostatic discharge portion 203a of the shaft 203. In one embodiment, the conductor 166 may actually come into electrical contact with the electrostatic discharge portion 203a. However, such contact cannot result in an electrical bypass of the radially outermost portion 179 of the conductor 166 that would electrically bridge any discontinuity in the radially outermost portion 179, thereby undermining the tread wear detection capability of the tread wear sensor plug 196.

In an additional embodiment, the portion of the electrostatic discharge portion 203a that coincides with the tread sensor extension 213 may have a larger diameter or cross sectional surface area to ensure enough cross sectional area exists for this section so that resistance of the electrostatic discharge portion 203a is not increased such that the ultimate tire resistance does not meet a given target resistance. To this end, the channel 183 may be made larger or of a different shape in this region to accommodate the larger cross sectional surface area of the electrostatic discharge portion 203a in this section.

It should be noted that the tread wear sensor plug 196 may be used in place of one of the conductive inserts 136 (FIG. 11). For example, in the case that a tire 130 (FIG. 11) includes multiple conductive inserts 136, at least one tread wear sensor plug 196 may be used along with the conductive inserts 136. In this manner, one or more tread wear sensor plugs 196 may be used in place of a conductive insert 136 in positions where it is desirable to provide for tread wear sensing on a given tire 130.

Referring now to FIGS. 9-12 and 15A-C, shown are various embodiments that include a chimney 119, a conductive insert 136, or the tread wear sensor plug 196 that includes the electrostatic discharge portion 203a, where the electrostatic discharge portion 203a acts in a similar manner to the conductive insert 126. It is understood that these various mechanisms may be employed to achieve a desired tire resistance for a given tire.

For example, if resistance of a given tire design must be reduced, one may increase the Width W (FIG. 9) of the chimney 119, increase the cross sectional area of conductive inserts 136, or increase the cross sectional area of the conductive portion of the electrostatic discharge portion 203a (FIGS. 15A-C) of the shaft 203 (FIGS. 15A-C). Also, one may add more chimneys 119, conductive inserts 136, and/or tread wear sensor plugs 196 to the tire. These approaches would result in a correspondingly greater cross sectional surface area of such components in the footprint of the tire, thereby translated into lower tire resistance.

Similarly, if resistance of a given tire design must be increased, one may decrease the Width W (FIG. 9) of the chimney 119, decrease the cross sectional area of conductive inserts 136, or decrease the cross sectional area of the conductive portion of the electrostatic discharge portion 203a (FIGS. 15A-C) of the shaft 203 (FIGS. 15A-C). Also, one may reduce the number of chimneys 119, conductive inserts 136, and/or tread wear sensor plugs 196 that fall into the footprint of a tire.

In the present disclosure, disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A tire, comprising:
a plurality of sidewalls, each one of the sidewalls extending radially outwardly from a respective bead to a tread, the tread comprising a plurality of tread elements;
a tire component positioned in the tire adjacent to the tread;
a chimney extending from the tire component through at least one tread element; and
the tire component and the chimney comprising a conductive rubber composition having an uncured or cured electrical resistance at 23° C. less than about 10 KΩ when formed into a wire about 254 millimeters long and 2 millimeters in diameter.

2. The tire of claim Error! Bookmark not defined., wherein the tire component comprises an undertread of the tire.

3. The tire of claim Error! Bookmark not defined., wherein the chimney comprises an annular chimney extending along an entire periphery of the tread.

4. The tire of claim Error! Bookmark not defined., wherein the chimney extends in an annular direction of the tire along at least a portion of the tread.

5. The tire of claim Error! Bookmark not defined., wherein a width of the annular chimney is specified to provide for a tire resistance of less than 10 MΩ.

5. The tire of claim Error! Bookmark not defined., wherein a width of the annular chimney is specified to provide for a tire resistance of less than 1 MΩ.

7. A tire, comprising:
a plurality of sidewalls, each one of the sidewalls extending radially outwardly from a respective bead to a tread, the tread comprising a plurality of tread elements;
a channel extending from an inside surface of the tire through at least a portion of one of the tread elements;
a tread wear plug including a shaft positioned in the channel, wherein a flange extends from a radially innermost end of the shaft;
a conductor embedded in the shaft, the conductor having a pair of ends terminating into a corresponding pair of sensor contacts in the flange;
a radially outermost portion of the conductor being positioned at a predefined depth with respect to an outer surface of the tread element; and
the conductor comprising a conductive rubber composition having an uncured or cured electrical resistance at 23° C. less than about 10 KΩ when formed into a wire about 254 millimeters long and 2 millimeters in diameter.

8. The tire of claim 7, further comprising:
an electrically active sensor having a pair of electrical contacts; and
each one of the pair of electrical contacts being in direct contact with a corresponding one of the sensor contacts.

6. The tire of claim 7, wherein
the channel extends from the inside surface of the tire to a radially outer surface of the one of the tread elements; and
a radially outermost surface of the shaft is flush with a radially outer surface of the one of the tread elements.

10. The tire of claim 7, wherein the predefined depth with respect to the outer surface of the tread element corresponds to a predefined minimum tread depth of the tire.

11. The tire of claim 7, wherein the channel is positioned on an equatorial plane of the tire.

12. The tire of claim 7, wherein a first distance between the channel and a lateral edge of the tread is greater than a second distance between the channel and the equatorial plane of the tread.

13. The tire of claim 7, wherein a distance between the channel and an equatorial plane of the tread is greater than a distance between the channel and a lateral edge of the tread.

14. A tire, comprising:
a plurality of sidewalls, each one of the sidewalls extending radially outwardly from a respective bead to a tread, the tread comprising a plurality of tread elements;
a channel extending from an inside surface of the tire to a radially outer surface of the one of the tread elements;
a tread wear plug including a shaft positioned in the channel, wherein a flange extends from a radially innermost end of the shaft;
a conductor embedded in a first portion of the shaft, the conductor having a pair of ends terminating into a corresponding pair of sensor contacts in the flange;
a radially outermost portion of the conductor being positioned at a predefined depth with respect to an outer surface of the tread element; and
the shaft comprises a second portion positioned at a radially outermost end of the shaft, the second portion being electrically coupled to a conductive element of the tire;
the conductor and the second portion comprising a conductive rubber composition having an uncured or cured electrical resistance at 23° C. less than about 10 KΩ when formed into a wire about 254 millimeters long and 2 millimeters in diameter.

15. The tire of claim 14, wherein the second portion further comprises a flange extending from a radially innermost end of the second portion.

16. The tire of claim 14, further comprising:
an electrically active sensor having a pair of electrical contacts; and
each one of the pair of electrical contacts being in direct contact with a corresponding one of the sensor contacts.

17. The tire of claim 14, wherein a radially outermost surface of the shaft is flush with a radially outer surface of the one of the tread elements.

18. The tire of claim 14, wherein the predefined depth with respect to the outer surface of the tread element corresponds to a predefined minimum tread depth of the tire.

19. The tire of claim 14, wherein the second portion of the shaft provides an electrical pathway from the conductive element of the tire to ground when the tread wear plug falls within a footprint of the tire.

20. The tire of claim 14, wherein the channel further comprises a first channel, the tire further comprising:
at least one second channel extending from the conductive component of the tire to the outer surface of the a radially outer surface of the one of the tread elements;
at least one conductive insert disposed in the at least one second channel, the at least one conductive insert contacting the conducting component of the tire and extending to an outer surface of at least one of the tread elements.
